(19) United States
(12) Patent Application Publication
(10) Pub. No.: US 2012/0030337 A1
(43) Pub. Date: Feb. 2, 2012

(54) APPARATUS AND METHOD FOR IDENTIFYING ACCESS TERMINAL

(75) Inventor: Yong Jung Bang, Daegu (KR)

(73) Assignee: LOG CORP., Daegu (KR)

(21) Appl. No.: 13/264,089

(22) PCT Filed: Jan. 28, 2010
(86) PCT No.: PCT/KR2010/000500

§ 371 Date: Oct. 12, 2011

(30) Foreign Application Priority Data
Apr. 17, 2009 (KR) 10-2009-0033628

(51) Int. Cl. G06F 15/16

(52) U.S. Cl. 709/223

(57) ABSTRACT

An apparatus for identifying an access terminal includes an application installation determination unit configured to generate information indicating whether or not each application on an application list is installed in the access terminal by determining whether or not each application on the application list is installed in the access terminal; and an access terminal identification code generating unit configured to generate an access terminal identification code of the access terminal by combining the information indicating whether or not each application is installed in the access terminal; and an access terminal identification unit configured to identify the access terminal by using the access terminal identification code.

### TECHNICAL FIELD

The present disclosure relates to a method for generating an access terminal identification code and an apparatus and method for identifying an access terminal by using the identification code.

### BACKGROUND ART

When an internet user visits an internet web site, information of the visitor such as an IP address, the number of times of access and the like is automatically stored in a web server of the web site. This information is called log information.

A web site operator analyzes log information and investigates behaviors of visitors in the web site, such as the number of visitors to the web site, the number of times of access, page views and the like. That is, base on the log information, the operator can analyze characteristics and behavior patterns of the visitors to the web site, including how many visitors are genuine visitors, through what channels they access the web site, and so forth.

A first step to investigate the characteristics of the visitors to the web site by analyzing the log information is to identify an access terminal. For the purpose, the web server can use an IP address of a visitor as an identifier or assign a unique ID to the access terminal. The unique ID assigned to the access terminal can be stored in, e.g., a cookie of the access terminal.

If the access terminal having the unique ID accesses the web site, the web server can identify the access terminal by reading out the unique ID of the access terminal that has accessed the web site.

However, the above-mentioned method of identifying the access terminal only by using the unique ID stored in the cookie or the like has a drawback in that the web server cannot identify the access terminal accurately if the ID address of the access terminal is frequently changed or if the cookie is removed from the access terminal.

### Disclosure of the Invention

### [Problems to be Solved by the Invention]

In view of the foregoing, the present disclosure provides a system and a method for accurately identifying an access terminal by using an access terminal identification code generated based on information indicating whether or not an application is installed in the access terminal.

Further, the present disclosure also provides a system and a method for accurately identifying an access terminal by using an access terminal identification code generated based on information indicating whether or not an application is installed in the access terminal, even in case an IP address of the access terminal is frequently changed or an access terminal identifier stored in, e.g., a cookie of the access terminal is removed.

Furthermore, the present disclosure also provides a method for generating an access terminal identification code by using information indicating whether or not an application is installed in an access terminal.

### [Means for Solving the Problems]

To solve the above-stated technical problems, in accordance with a first aspect of the present disclosure, there is provided an apparatus for identifying an access terminal, including: an application installation determination unit configured to generate information indicating whether or not each application on an application list is installed in the access terminal by determining whether or not each application on the application list is installed in the access terminal; and an access terminal identification code generating unit configured to generate an access terminal identification code of the access terminal by combining the information indicating whether or not each application is installed in the access terminal; and an access terminal identification unit configured to identify the access terminal by using the access terminal identification code.

Further, in accordance with a second aspect of the present disclosure, there is provided a method for identifying an access terminal, including: determining whether or not each application on an application list is installed in the access terminal; generating information indicating whether or not each application is installed based on the determination result; generating an access terminal identification code of the access terminal by combining the information indicating whether or not each application is installed; and identifying the access terminal by using the access terminal identification code.

Moreover, in accordance with a third aspect of the present disclosure, there is provided a method for generating an access terminal identification code, including: determining whether or not each application on an application list is installed in an access terminal; generating information indicating whether or not each application is installed based on the determination result; and generating an access terminal identification code of the access terminal by combining the information indicating whether or not each application is installed.

### [Advantageous Effects]

In accordance the present disclosure, it is possible to identify an access terminal by using information indicating whether or not an application is installed in the access terminal.

Further, in accordance with the present disclosure, since the access terminal is identified based on the information indicating whether or not the application is installed in the access terminal as well as based on an ID address of the access terminal or the identifier thereof stored in the cookie of the like, it is possible to identify the access terminal more accurately. Further, even in case the IP address is changed frequently or the cookie is removed, it is still possible to identify the access terminal.

### [BRIEF DESCRIPTION OF THE DRAWINGS]

FIG. 1 is a schematic configuration view of a system for providing access statistics information;

FIG. 2 is a detailed configuration view of an access terminal identifying apparatus in accordance with an embodiment of the present disclosure;

FIG. 3 is a table illustrating an application list in accordance with an embodiment of the present disclosure;

FIG. 4 illustrates an access terminal identification code generation table storing therein access terminal identification codes and information indicating whether or not each application is installed;

FIG. 5 is a flowchart of an access terminal identification code generating method in accordance with an embodiment of the present disclosure; and

FIG. 6 is a flow chart of a method by which an access terminal identifying apparatus identifies an access terminal in accordance with an embodiment of the present disclosure.

### BEST MODE FOR CARRYING OUT THE INVENTION

Hereinafter, embodiments of the present disclosure will be described in detail with reference to the accompanying drawings so that the present disclosure may be readily implemented by those skilled in the art. However, it is to be noted that the present disclosure is not limited to the embodiments but can be realized in various other ways. In drawings, parts irrelevant to the description are omitted for the simplicity of explanation, and like reference numerals denote like parts through the whole document.

Through the whole document, the term “connected to” or “coupled to” that is used to designate a connection or coupling of one element to another element includes both a case that an element is “directly connected or coupled to” another element and a case that an element is “electrically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements.

Hereinafter, the present disclosure will be discussed in detail with reference to the accompanying drawings.

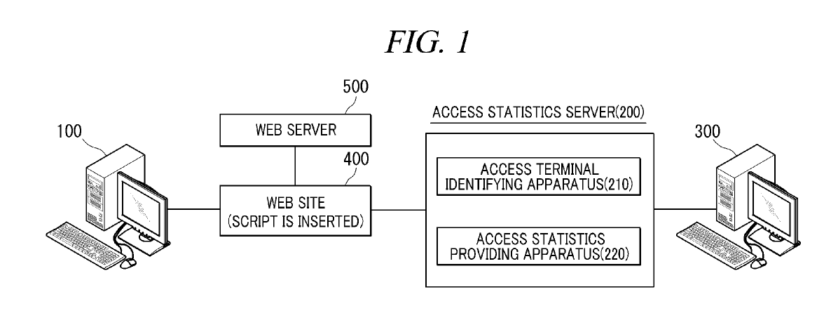

FIG. 1 is a schematic configuration view of a system for providing access statistics information in accordance with an embodiment of the present disclosure.

As shown in FIG. 1, the system for providing access statistics information may include an access terminal 100, an access statistics server 200 and a manager terminal 300.

The access terminal 100 may access a portal site (not shown) provided by a portal site server (not shown) and input a search word. Then, the access terminal 100 can access a web site 400 through a web server 500 by clicking a CPC (Cost Per Click) advertisement or by clicking a banner advertisement or a URL address linked to the web site 400. Alternatively, the access terminal 100 can also access the web site 400 by directly inputting a URL address of the web site 400 through a web browser installed in the access terminal 100. For the purpose, the access terminal 100 has an IP address for internet access and the web browser for internet browsing.

An access statistics generation script for log analysis may be inserted in the web site 400. The script included in the web site 400 may transmit access information to the access statistics server 200 when the browser driven in the access terminal 100 loads or unloads a web page.

The access statistics server 200 may include an access terminal identifying apparatus 210 and an access statistics providing apparatus 220.

The access terminal identifying apparatus 210 is capable of identifying the access terminal 100 by generating an access terminal identification code. The access terminal identification code is generated based on information (hereinafter, referred to as “installation state information”) indicating whether or not various applications installable in the access terminal 100 are installed in the access terminal 100 or based on information indicating versions of those applications.

By way of example, the access terminal identifying apparatus 210 generates the installation state information by determining whether or not each application is installed in the access terminal 100 by referring to an application list. Further, when it is required to check version information of a certain application installed in the access terminal 100, the access terminal identifying apparatus 210 may check the version of the application. Then, the access terminal identifying apparatus 210 is capable of generating an access terminal identification code composed of a series of characters or numbers by combining the installation state information and/or the version information of the applications.

In response to a request from the manager terminal 300, the access statistics providing apparatus 220 may generate access statistics information including the total number of times of access to the web site 400, the number of genuine visitors, the number of conversions, a conversion rate with respect to the total number of times of access, a conversion rate with respect to the total number of genuine visitors, residence time during which the visitors are kept connected to the web site 400, and so forth. The access statistics providing apparatus 220 may provide the generated access statistics information to the manager terminal 300.

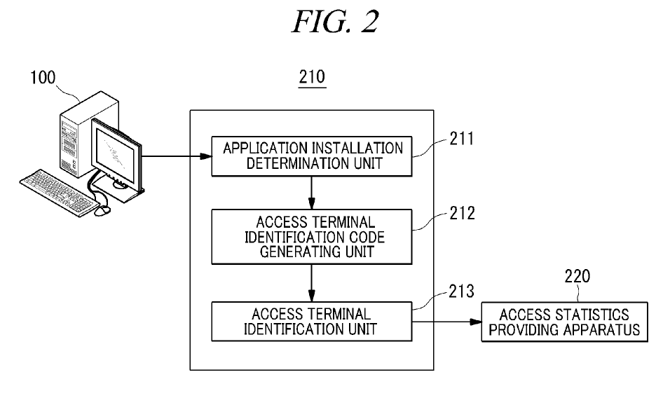

A detailed configuration of the access terminal identifying apparatus 210 will be elaborated with reference to FIG. 2.

FIG. 2 is a detailed configuration view of the access terminal identifying apparatus in accordance with the embodiment of the present disclosure.

As depicted in FIG. 2, the access terminal identifying apparatus 210 in accordance with the embodiment of the present disclosure may include an application installation determination unit 211, an access terminal identification code generating unit 212 and an access terminal identification unit 213.

For reference, each of components illustrated in FIG. 2 in accordance with the embodiment of the present invention may imply software or hardware such as a field programmable gate array (FPGA) and an application specific integrated circuit (ASIC), and they carry out a predetermined function.

However, the components are not limited to the software or the hardware, and each of the components may be stored in an addressable storage medium or may be configured to implement one or more processors.

By way of example, the components may include software, object-oriented software, classes, tasks, processes, functions, attributes, procedures, sub-routines, segments of program codes, drivers, firmware, micro codes, circuits, data, database, data structures, tables, arrays, variables or the like.

The components and functions thereof can be combined with each other or can be divided.

The application installation determination unit 211 is capable of determining which applications are installed in each access terminal 100. That is, by referring to a list of various predetermined applications that can be installed in the access terminal, the application installation determination unit 211 determines which applications are installed and which applications are not.

For example, the application installation determination unit 211 has a list of Active X and Plug-in programs and various application programs installable in the access terminal 100. The application installation determination unit 211 is capable of determining which applications are installed in the access terminal by referring to such a list.

Based on this determination result, the application installation determination unit 211 is also capable of generating information (installation state information) indicating whether or not an application is installed.

By way of example, when the determination result reveals that an application is installed in the access terminal 100, the application installation determination unit 211 stores a first symbol as installation state information of the application. On the other hand, when it is found that the application is not installed in the access terminal, a second symbol different from the first symbol is stored as the installation state information of the application.

Here, the first and second symbols may be characters or numbers.

For example, installation state information can be generated by assigning the symbol “1” to an application installed in the access terminal 100. On the other hand, as for an application which is not installed in the access terminal 100, installation state information may be generated by using the symbol “0”.

Moreover, the application installation determination unit 211 is also capable of acquiring version information of each application.

When a version of the application installed in the access terminal 100 needs to be checked, the application installation determination unit 211 is capable of checking and storing the version of the application by using a preset algorithm.

As for the application installed in the access terminal 100, the application installation determination unit 211 can also check and store the version information of the application even in case that the installation state information of the application is previously generated by using the first symbol. That is, for the application installed in the access terminal 100, it is possible to generate both of the installation state information and the version information or to generate either one of them.

The access terminal identification code generating unit 212 is capable of generating an access terminal identification code by combining the installation state information of the applications generated by the application installation determination unit 211. Moreover, the access terminal identification code generating unit 212 can generate the access terminal identification code by additionally using the version information as well.

The access terminal identification code generating unit 212 is capable of generating a unique access terminal identification code for each access terminal by combining the first and second symbols or by additionally combining the version information with the combinations of the first and second symbols.

Here, the access terminal identification code generated by the access terminal identification code generating unit 212 can be deleted after temporarily stored for a preset time.

The access terminal identification unit 213 is capable of identifying the access terminal 100 by using the access terminal identification code generated by the access terminal identification code generating unit 212.

Moreover, after identifying the access terminal 100 by using the access terminal identification code, the access terminal identification code generating unit 212 is capable of transmitting the identification information upon the access terminal 100 to the access statistics providing apparatus 220.

Here, the access terminal 100 may include a desktop computer, a notebook computer, a laptop computer, a personal portable terminal, and so forth. The portable terminal refers to a wireless communication device having portability and mobility, and it includes various kinds of handheld wireless communication devices such as, but not limited to, PCS (Personal Communication System), GSM (Global System for Mobile communications), PDC (Personal Digital Cellular), a PDA (Personal Digital Assistant), CDMA (Code Division Multiple Access)-2000, W-CDMA(W-Code Division Multiple Access), Wibro (Wireless Broadband Internet) terminals.

By using the access terminal identifying apparatus 210 in accordance with the embodiment of the present disclosure, access terminal identification codes are generated by combining installation state information and/or version information of a number of applications that can be installed in the access terminals 100. Accordingly, a unique identification code can be assigned to each access terminal 100 and the identification codes are not overlapped between the access terminals 100. Hence, the access terminals 100 can be easily identified.

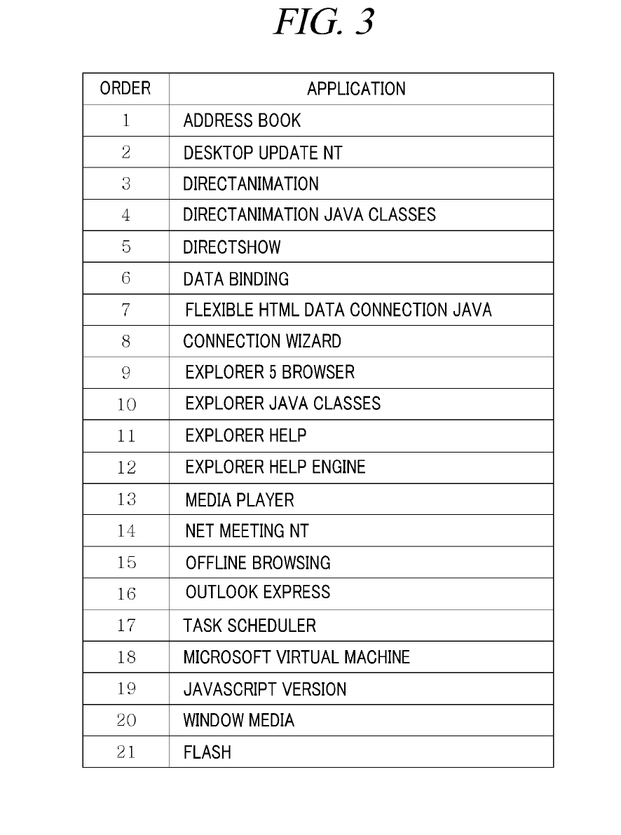

FIG. 3 is a table showing an application list in accordance with an embodiment of the present disclosure.

The application list in accordance with the embodiment includes Active X and Plug-in programs and various application programs that can be installed in the access terminal.

By way of example, the applications that can be installed in the access terminal may include “Media player,” “Explorer,” “Outlook Express,” “Address Book,” and the like. In FIG. 3, although only 21 applications are recorded in the application list, the application list in accordance with the embodiment of the present disclosure may include a wider range of applications.

Accordingly, by the access terminal identifying apparatus and method in accordance with the above-described embodiment of the present disclosure, at least 2²¹ number of access terminals can be identified.

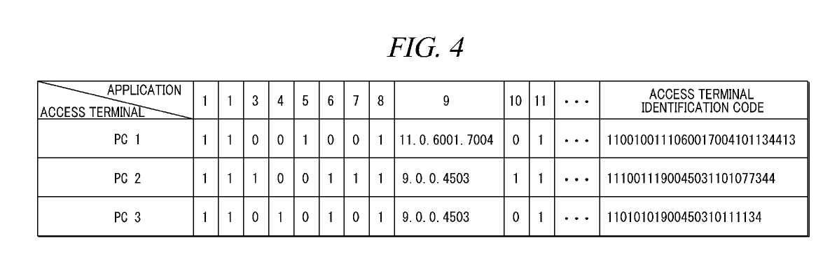

FIG. 4 shows an access terminal identification code generation table in which installation state information of applications and access terminal identification codes are stored.

As shown in FIG. 4, in the access terminal identification code generation table in accordance with the embodiment of the present disclosure, installation state information or version information of each application can be stored for each access terminal.

For example, among the applications on the application list shown in FIG. 3, assume that it is found as a result of checking applications installed in the first access terminal that applications such as “Address Book,”, “Desktop Update NT” and “Direct Show” are installed whereas applications such as “Direct Animation” and “Direct Animation Java Classes” are not installed. In such a case, “1” or “0” may be stored in fields corresponding to the respective application numbers. That is, 1 may be stored in a field corresponding to the first application; 1, in a field corresponding to the second application; 0, in a field corresponding to the third application; 0, in a field corresponding to the fourth application; and 1, in a field corresponding to the fifth application.

In this way, the application installation determination unit 211 can check installation states of all the applications on the application list; generate installation state information of those applications by using the first and second symbols; and store the installation state information in the access terminal identification code generation table.

Further, besides the first and second symbols related to the installation states of the applications, the version information of those applications can also be stored in the access terminal identification code generation table.

By way of example, for the ninth application “Explorer 5 Browser” among the listed applications in FIG. 3, the application installation determination unit 211 can check version information thereof by using a preset algorithm. The version information may be stored in the ninth field corresponding to “Explorer 5 Browser” in the access terminal identification code generation table. In this way, the application installation determination unit 211 is capable of checking version information of applications of which versions need to be checked among the applications on the application list. The checked version information can be stored in the access terminal identification code generation table.

It is shown in FIG. 4 that only the version information is stored in the field corresponding to the ninth application. However, as in the other fields, only the installation state information of the application may be stored by using the first and second symbols or both the installation state information and the version information may be stored together.

After the installation state information or the version information of all the applications on the application list are completely checked and stored in the access terminal identification code generation table, the access terminal identification code generating unit 212 may generate an access terminal identification code composed of a series of characters or number by combining the first and second symbols and/or the version information and store the generated access terminal identification code in the access terminal identification code generation table.

The access terminal identification code may be generated by connecting in sequence the symbols and/or the version information stored in the fields corresponding to the first to the last applications.

By way of example, the access terminal identification code generating unit 212 can generate an access terminal identification code by connecting in sequence the numbers, except characters such as “.”, in the symbols and version information stored in the field corresponding to each application. For example, for the symbols and version information of 1,1,0,0,1,0,0,1,11.0.6001.7004,1,0, an access terminal identification code of 110010011106001700410 can be generated.

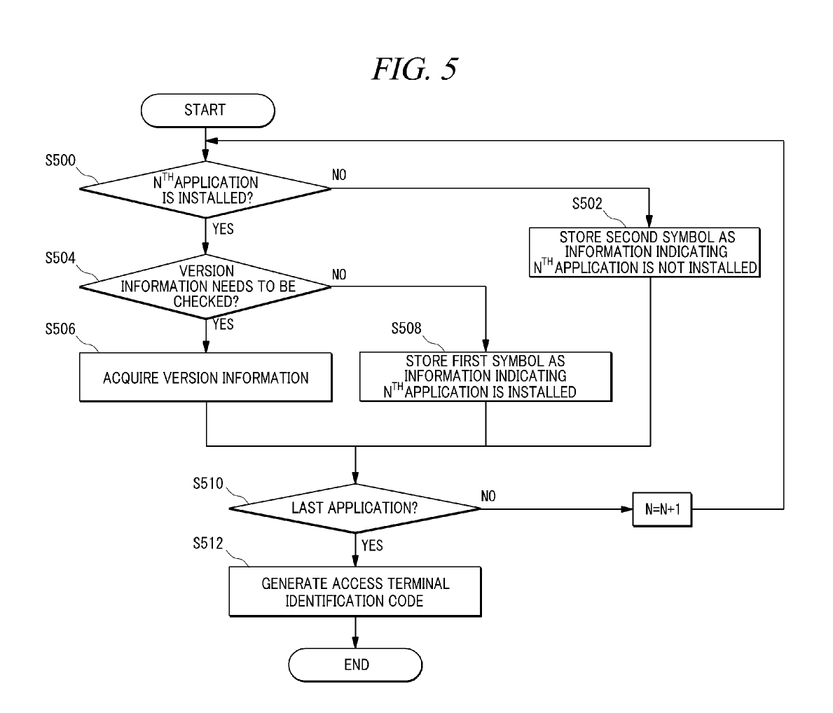

FIG. 5 is a flowchart for describing an access terminal identification code generating method in accordance with an embodiment of the present disclosure.

In step S500, the application installation determination unit 211 determines whether or not each application program on the application list is installed in the access terminal. To elaborate, in step S500, the application installation determination unit 211 refers to the application list and determines whether or not the n^{th} application is installed in the access terminal.

By way of example, the application installation determination unit 211 has a list of Active X programs, Plug-in programs and various application programs that can be installed in the access terminal. The application installation determination unit 211 is capable of determining which application program is installed in the access terminal by referring to the list.

If it is determined in step S500 that the n^{th} application is not installed in the access terminal, the application installation determination unit 211 stores the second symbol as installation state information of the n^{th} application in step S502. For example, when the n^{th} application is not installed in the access terminal, the application installation determination unit 211 may store “0” in a field corresponding to the n^{th} application in the access terminal identification code generation table.

On the other hand, if it is determined in step 5500 that the n^{th} application is installed in the access terminal, the application installation determination unit 211 may determine, in step S504, whether or not version information of the n^{th} application needs to be checked or not.

If it is determined in step S504 that the version of the n^{th} application needs to be checked, the application installation determination unit 211 acquires version information of the n^{th} application in step S506. For example, in step S506, the application installation determination unit 211 can acquire the version information of the application installed in the access terminal by using a preset algorithm.

On the other hand, if it is determined in step S504 that the version information of the n^{th} application need not be checked, the application installation determination unit 211 may store the first symbol as the installation state of the n^{th} application. For example, the application installation determination unit 211 may store “1” in the field corresponding to the n^{th} application in the access terminal identification code generation table.

Referring to FIG. 5, it is shown that only the version information is acquired in case that the n^{th} application is installed in the access terminal and the version information thereof needs to be checked. However, for the n^{th} application, the first symbol can also be stored as the installation state information.

In step S510, it is determined whether the n^{th} application is the last application on the application list.

If it is determined in the step S510 that the n^{th} application is not the last application, the application installation determination unit 211 proceeds to check at least one of an installation state and a version of the next application, i.e., the (n+1)^{th} application and generate at least one of installation state information and version information of the (n+1)^{th} application.

In step S512, the access terminal identification code generating unit 212 generates an access terminal identification code by combining the installation state information and/or the version information of the application.

By way of example, the access terminal identification code generating unit 212 is capable of generating a unique access terminal identification code for each access terminal by combining the version information and/or the first and second symbols stored in steps S502, S506 and S508. The access terminal identification code may be composed of a series of characters of numbers.

As stated above, in accordance with the access terminal identification code generating method in accordance with the embodiment of the present disclosure, access terminal identification codes can be generated by combining installation state information and/or version information of a number of applications that can be installed in access terminals. The access terminal identification codes are not overlapped between the access terminals. Thus, it is possible to assign a unique identification code to each access terminal and the access terminals can be easily identified.

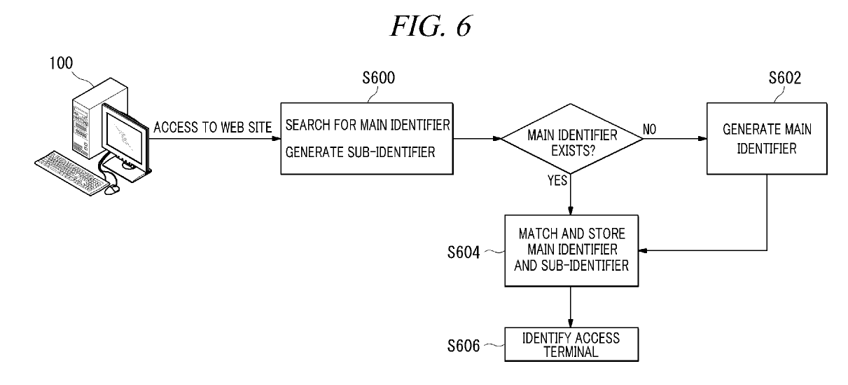

FIG. 6 is a flowchart for describing a method by which the access terminal identifying apparatus in accordance with the embodiment of the present disclosure identifies an access terminal.

The access terminal 100 is capable of accessing a web site through a wired network such as a local area network (LAN), a wide area network (WAN) or a value added network (VAN) or various kinds of wireless networks such as a mobile radio communication network, a satellite communication network, Bluetooth, Wibro (Wireless Broadband Internet) and HSDPA (High Speed Downlink Packet Access).

In step S600, the access terminal identifying apparatus reads a main identifier stored in any one of a cookie of the access terminal 100, user data using a userData Behavior and flash data using a share object of Macromedia Flash in order to identify the access terminal 100 that has accessed the web site.

Here, the main identifier is a unique identifier assigned to the access terminal 100 to allow the access terminal 100 to be distinguishable from other access terminals. The main identifier may be generated by a combination of various parameters such as user's account, password and IP address.

For reference, a storage capacity of the user data is about 1 MB and a storage capacity of the flash data is about 100 KB. Further, the flash data has an advantage in that there is no limit in the number of items that can be stored. Further, the capacity of the flash data can be expanded up to the maximum of about 512 KB through a process of requesting a user's consent when a stored data amount exceeds the storage capacity. Thus, it can be prevented that previously stored data is deleted when the data amount exceeds the storage capacity. Furthermore, as for the flash memory, since data sharing is prohibited between independent shockwave flash files (swf), the flash memory is also advantageous in consideration of security problems.

Moreover, the user data and the flash data also has advantages in that functions of deleting and reading these data are not provided even by a web browser and these data cannot be modified or read by a virus vaccine.

Besides, the access terminal identifying apparatus can also read an IP address or a MAC address of the access terminal 100 in order to identify the access terminal 100.

Further, in step S600, the access terminal identifying apparatus may generate a sub-identifier in order to identify the access terminal 100 that has accessed the web site. The sub-identifier can be used when it is impossible to identify the access terminal by using the main identifier. For example, the sub-identifier can be used when the user data or the flash data in which the main identifier is stored is deleted and there exists no main identifier or when the access terminal 100 cannot be identified because the IP address of the access terminal 100 is too frequently changed.

The sub-identifier is an access terminal identification code generated base on the installation state information and/or the version information of the various applications that can be installed in the access terminal.

By way of example, the access terminal identifying apparatus determines whether or not each application on the application list is installed in the access terminal 100 by referring to the application list.

Then, for an application installed in the access terminal 100, the access terminal identifying apparatus may store a first symbol as installation state information. Meanwhile, for an application that is not installed in the access terminal 100, a second symbol different from the first symbol may be stored as installation state information.

Moreover, when version information of the application installed in the access terminal needs to be checked, the version of that application can be checked by using a preset algorithm.

Then, the access terminal identifying apparatus may generate a sub-identifier, i.e., an access terminal identification code composed of a series of characters or numbers by combining the first and second symbols and/or the version information.

As a result of searching for the main identifier of the access terminal 100 that has accessed the web site, if it is found that there is no main identifier, the access terminal identifying apparatus generates a main identifier corresponding to the access terminal 100 in step S602. By way of example, the access terminal identifying apparatus may use the IP address or the like of the access terminal 100 as the main identifier and such a main identifier may be stored in correspondence to the access terminal 100.

Further, as a result of searching for the main identifier of the access terminal 100 that has accessed the web site, if the main identifier is found, the access terminal identifying apparatus may generate an access terminal identifier by combining the main identifier and the sub-identifier.

Further, the access terminal identifying apparatus may generate an access terminal identifier by combining the main identifier generated in step S602 with the sub-identifier in step S604.

At this time, since the sub-identifier is temporarily used to identify the access terminal 100 when the main identifier is deleted or temporarily unusable, the sub-identifier may be temporarily stored for a preset time while matched with the main identifier and the deleted later.

In step S606, the access terminal identifying apparatus identifies the access terminal by using the access terminal identifier generated in step S604.

The embodiment of the present invention can be implemented by storage medium including computer executable commands such as a program module executed on a computer. The computer readable medium may be any medium accessible by the computer, and it includes both volatile and non-volatile medium, and both detachable and non-detachable medium. Further, the computer readable medium includes both computer storage medium and communication medium. The computer storage medium includes volatile and non-volatile media, and detachable and non-detachable media implemented by a method or technique for storing information such as computer readable commands, data structures, program modules, miscellaneous data, and so forth. The communication medium typically includes computer readable commands, data structures, program modules or miscellaneous data of a modulated data signal such as carrier wave, or a miscellaneous transmission mechanism, and it has an information transmission medium.

The above description of the present invention is provided for the purpose of illustration, and it would be understood by those skilled in the art that various changes and modifications may be made without changing technical conception and essential features of the present invention. Thus, it is clear that the above-described embodiments are illustrative in all aspects and do not limit the present invention. For example, each component describe to be of a single type can be implemented in a distributed manner. Likewise, components described to be distributed can be implemented in a combined manner.

The scope of the present invention is defined by the following claims rather than by the detailed description of the embodiment. It shall be understood that all modifications and embodiments conceived from the meaning and scope of the claims and their equivalents are included in the scope of the present invention.

What is claimed is:

1. An apparatus for identifying an access terminal, comprising:
an application installation determination unit configured to generate information indicating whether or not each application on an application list is installed in the access terminal by determining whether or not each application on the application list is installed in the access terminal; and
an access terminal identification code generating unit configured to generate an access terminal identification code of the access terminal by combining the information indicating whether or not each application is installed in the access terminal; and
an access terminal identification unit configured to identify the access terminal by using the access terminal identification code.

2. The apparatus of claim 1, wherein the application installation determination unit stores a first symbol as the information indicating whether or not each application is installed when it is determined that each application is installed, whereas the application installation determination unit stores a second symbol as the information indicating whether or not each application is installed when it is determined that each application is not installed.

3. The apparatus of claim 1, wherein the application installation determination unit acquires version information of each application and the access terminal identification code is generated by additionally using the version information.

4. A method for identifying an access terminal, comprising:
determining whether or not each application on an application list is installed in the access terminal;
generating information indicating whether or not each application is installed based on the determination result;
generating an access terminal identification code of the access terminal by combining the information indicating whether or not each application is installed; and
identifying the access terminal by using the access terminal identification code.

5. The method of claim 4, further comprising:
acquiring version information of each application,
wherein the access terminal identification code is generated by additionally using the version information.

6. The method of claim 4, further comprising:
generating an access terminal identifier by combining the access terminal identification code with an IP address of the access terminal or by combining the access terminal identification code with identification information inserted in at least one of a cookie, a user data and a flash data; and
identifying the access terminal by using the access terminal identifier.

7. A method for generating an access terminal identification code, comprising:
determining whether or not each application on an application list is installed in an access terminal;
generating information indicating whether or not each application is installed based on the determination result; and
generating an access terminal identification code of the access terminal by combining the information indicating whether or not each application is installed.

8. The method of claim 7, wherein the generating information indicating whether or not each application is installed comprises:
storing a first symbol as the information indicating whether or not each application is installed when it is determined that each application is installed; and
storing a second symbol as the information indicating whether or not each application is installed when it is determined that each application is not installed.

9. The method of claim 7, further comprising:
checking version information of each application installed in the access terminal when a version of each application needs to be checked,
wherein the access terminal identification code is generated by additionally using the version information.
